(19) United States
(12) Patent Application Publication
(10) Pub. No.: US 2005/0221003 A1
(43) Pub. Date: Oct. 6, 2005

(54) Enhancement of SiO2 deposition using phosphorus (V) compounds

(76) Inventor: Michael P. Remington JR., Toledo, OH (US)

Correspondence Address: MARSHALL & MELHORN, FOUR SEAGATE, EIGHT FLOOR, TOLEDO, OH, 43604, US

(21) Appl. No.: 10/814,873

(22) Filed: Mar. 31, 2004

(51) Int. Cl. B32B 17/06

(52) U.S. Cl. 427/248.1; 428/428

(57) ABSTRACT

A process is defined for depositing a silica coating upon a heated glass substrate. The process includes providing a heated glass substrate having a surface upon which the coating is to be deposited. A precursor mixture comprising a silane, an oxygen source, a radical scavenger, a phosphorous (V) compound and an inert carrier gas is directed toward and along the surface to be coated. The mixture is reacted at or near the surface to form a silica coating on the surface of the glass substrate.

### BACKGROUND OF THE INVENTION

1. Field of the Invention

The present invention relates to a continuous, chemical vapor deposition (CVD) method for producing a coated glass article, particularly, to an improved method for producing a glass article coated with a layer of silica (SiO₂), and the coated glass article formed thereby. Specifically, to a method for producing a coated architectural glass or automotive glass, and to the coated article so produced

2. Summary of Related Art

U.S. Pat. No. 4,019,887 to Kirkbride et al. discloses the coating of glass with a layer of silicon or a silica complex by continuous chemical treatment of a hot glass substrate with a non-oxidizing gas containing a monosilane. Inclusion of ethylene in the non-oxidizing gas of the Kirkbride et al. process to improve resistance of the silica complex layer to attack by alkali compounds is described in U.S. Pat. No. 4,188,444 to Landau.

A method of pyrolytically forming a silica-containing coating on a glass substrate at an elevated temperature is found in U.S. Pat. Nos. 5,798,142, 5,798,142 is hereby incorporated by reference as if set forth in its entirety herein. In this patent, silane, oxygen, a radical scavenger gas and a carrier gas are combined as a precursor mixture, and the precursor is directed toward and along the surface of the heated glass substrate. The presence of the radical scavenger allows the silane, which is pyrophoric, to be premixed with the oxygen without undergoing ignition and premature reaction at the operating temperatures. The radical scavenger further provides control of and permits optimization of the kinetics of the chemical vapor deposition (CVD) reaction on the glass. A preferred combination of precursor materials includes monosilane and oxygen, with ethylene as the radical scavenger, and includes nitrogen or helium as a carrier gas.

Known processes for the production of silica layers on a substrate through CVD processes are limited in the thickness or efficiency of the deposition process, and also by powder formation (pre-reaction) of the reactive elements. Therefore, it is desired to devise an improved process for the formation of silica layers on a substrate.

### SUMMARY OF THE INVENTION

In accordance with the present invention, there is provided an improved method for the deposition of a silica layer on a substrate. A silica layer, as defined herein, is a coating containing primarily silicon dioxide, and possibly containing trace contaminants, for example carbon or phosphorous. Specifically, the invention relates to a process for depositing a silica coating upon a heated glass substrate. The process includes providing a heated glass substrate having a surface upon which the coating is to be deposited. A precursor mixture comprising a silane, an oxygen source, a radical scavenger, a phosphorous (V) compound and an inert carrier gas is directed toward and along the surface to be coated. The mixture is reacted at or near the surface to form a silica coating on the surface of the glass substrate.

### DETAILED DESCRIPTION OF THE PREFERRED EMBODIMENT

The method of the present invention is preferably carried out in an on-line, float glass production process, which is well known in the art. An example of such a process can be found in U.S. Pat. No. 5,798,142 which was described hereinabove, and which has been incorporated by reference herein.

In a preferred embodiment of the present invention, a heated glass substrate is provided, the substrate having a surface on which the coating is to be deposited. A silane, oxygen, a phosphorous (V) compound, an inert carrier gas and a radical scavenger gas, are combined to form a precursor mixture, which is directed toward and along the surface to be coated, preferably in a laminar flow. The mixture is reacted at or near the surface of the glass substrate to form the silica coating. Subsequently, the coated glass substrate is cooled to ambient temperature.

Preferably, the inert carrier gas is either helium or nitrogen or a combination thereof. While other silanes may be used in embodiments of the present invention, it has been found that monosilane is the preferred silane for use in the present invention. Oxygen gas is the preferred oxygen source for use in the present invention, but it is possible, within the scope of the present invention, that other oxygen sources may also be used. The radical scavenger used in the present invention is preferably ethylene, but other known radical scavengers may be used in embodiments of the present invention.

It has been found, in conjunction with the present invention, that a preferred phosphorous (V) compound for use in the invention is a phosphorous (V) ester. Most preferably, it has been found that triethylphosphate (TEPO) can work especially well in conjunction with the present invention.

The use of a phosphorous (V) compound, specifically triethylphosphate, has been found to enhance the deposition of silica from known silane/oxygen/radical scavenger deposition systems. It has been experimentally found that the thickness of the deposited layer could be increased by between about 15 to about 100% as compared to known systems.

As understood, the mechanism resulting in the improved deposition results is that the inclusion of TEPO affects the reaction profile by forcing the reaction to take place over the entire coater face as opposed to directly under the nozzle. This can greatly decrease pre-reaction and powder formation of the precursor materials, and can greatly increase manufacturing times and efficiencies.

It has been found that, in general, about 0.5 to about 3.5 percent gas phase concentration of TEPO is sufficient to gain the above discussed reaction benefits. It has surprisingly been found that surprisingly small amounts of phosphorous are then incorporated into the film, resulting in essentially “pure” layers of silica, thus essentially not affecting the desired optical properties of a silica layer. It has been found that the concentration of phosphorous in the silicon dioxide coating formed according to the method of the present invention can be less than about 4 atomic percent. Similarly, a coated glass article formed according to the method of the present invention can have a refractive index between about 1.43 and about 1.59.

In a preferred embodiment of the present invention, the precursor mixture comprises about 0.1 to about 3.0 percent silane, about 0.4 to about 12.0 percent oxygen, about 0.6 to about 18.0 percent ethylene, about 0.1 to about 7.0 percent triethyl phosphate, with the remainder comprising inert carrier gas. The above concentrations are expressed in gas phase percentages.

Even more preferably, the precursor mixture of the present invention comprises: about 1.0 percent silane, about 6.0 percent oxygen, about 6.0 percent ethylene and about 1.5 percent triethyl phosphate, with the remainder comprising inert carrier gas.

While the use of phosphorous (III) compounds, for example triethylphosphite, has been known in the art, the use of phosphorous (V) compounds offers several advantages. Specifically, triethylphosphite has generally been used in conjunction with silica sources containing a silicon-oxygen bond, for example TEOS. Triethylphosphate, as discussed herein, works well with silicon precursors without oxygen bonds, for example monosilane, as discussed herein. Additionally, triethylphosphite (as well as most all phosphites, phosphines, etc.) is a highly noxious compound and can be difficult to work with because of the odors involved. Triethylphosphate, however, is a fully oxidized compound and thus does not have this highly offensive odor. Thus, triethylphosphate is much more appealing compound from a manufacturing standpoint.

As noted above, an increased deposition rate of silicon dioxide can be achieved through the use of the present invention. Coatings formed according to the method of the present invention can have a variety of thicknesses, with thicknesses of the silica coating preferably being between about 100 and about 1500 Angstroms.

Experimental results indicate that silica coatings can be formed from merely a combination monosilane and triethyl phosphate. However, it has been found that preferred results are obtained from use of the triethylphosphate in a silane/oxygen/ethylene system.

### EXAMPLES

The following examples, which constitute the best mode presently contemplated by the inventors for practicing the present invention, are presented solely for the purpose of further illustrating and disclosing the present invention, and are not to be construed as a limitation on the invention:

The following examples in Table 1 reflect samples run under laboratory conditions. All of the samples were deposited on a glass substrate having a temperature of about 1170 ° F.:

TABLE 1

| Sample | % | | | | Thickness | % increase |
|---|---|---|---|---|---|---|
| # | SiH4 | % C2H4 | % O2 | % TEPO | (angstroms) | from base |
| 1 | 1 | 6 | 6 | 0.00 | 495 | N/A |
| 2 | 1 | 6 | 6 | 0.45 | 695 | 40.4 |
| 3 | 1 | 6 | 6 | 1.34 | 803 | 62.2 |
| 4 | 1 | 6 | 6 | 2.23 | 615 | 24.2 |

The following examples in Table 2 reflect actual experimental results carried out in an line float glass system. All of the examples were run with a 1% vapor phase concentration of monsilane. The films were deposited on a fluorine doped tin oxide layer, and were then chemically etched and profiled to determine the thicknesses.

TABLE 2

| | Total | | | | | |
|---|---|---|---|---|---|---|
| Sample | flow | | | | Thickness | % increase |
| # | (slm) | % C2H4 | % O2 | % TEPO | (angstroms) | from base |
| 5 | 575 | 4.5 | 3.0 | 0.00 | 313 | N/A |
| 6 | 575 | 4.5 | 3.0 | 0.75 | 369 | 17.9 |
| 7 | 575 | 4.5 | 6.0 | 0.75 | 425 | 35.8 |
| 8 | 575 | 4.5 | 6.0 | 1.50 | 409 | 30.7 |
| 9 | 575 | 4.5 | 3.0 | 1.50 | 396 | 26.5 |

It can be seen from the above that each of the samples including TEPO in the precursor mixture indicated a significant increase in thicknesses of the deposited layer compared to samples 1 and 5, which do not include TEPO and was used as a baseline. Experimental results to a greater than 60% increase in the thickness of the silica layer were demonstrated from the inclusion of TEPO in the precursor mixture.

In accordance with the provisions of the patent statutes, the present invention has been described in what is considered to represent its preferred embodiment. However, it should be ed that the invention can be practiced otherwise than as specifically illustrated and described without departing from its spirit or scope.

1. A process for depositing a silica coating upon a heated glass substrate comprising:
a) providing a heated glass substrate having a surface upon which the coating is to be deposited; and
b) directing a precursor mixture comprising a silane, an oxygen source, a radical scavenger, a phosphorous (V) compound and an inert carrier gas toward and along the surface to be coated, and reacting the mixture at or near the surface to form a silica coating on the surface of the glass substrate.

2. The process for depositing a silica coating upon a glass substrate as claimed in claim 1, wherein the phosphorous (V) compound comprises a phosphorous ester.

3. The process for depositing a silica coating upon a glass substrate as claimed in claim 1, wherein the phosphorous (V) compound comprises triethylphosphate.

4. The process for depositing a silica coating upon a glass substrate as claimed in claim 1, wherein the silane is monosilane.

5. The process for depositing a silica coating as claimed in claim 1, wherein the inert carrier gas comprises at least one of nitrogen and helium.

6. The process for depositing a silica coating as claimed in claim 1, wherein the radical scavenger is ethylene.

7. The process for depositing a silica coating as claimed in claim 1, wherein the oxygen containing material is oxygen gas.

8. The process for depositing a silica coating as claimed in claim 3, wherein the precursor mixture comprises about 0.1 to about 3.0 percent silane, about 0.4 to about 12.0 percent oxygen, about 0.6 to about 18.0 percent ethylene and about 0.1 to about 7.0 percent triethylphosphate, with the remainder comprising an inert carrier gas.

9. A coated glass article formed according to the process of claim 1.

10. The coated glass article according to claim 9, wherein the refractive index of the coating is between about 1.43 and about 1.59.

11. The coated glass article according to claim 9, wherein said coating has a thickness between about 100 and about 1500 Angstroms.

12. The coated glass article according to claim 9, wherein said coating comprises less than about 4 atomic percent phosphorous.

13. A process for depositing a silica coating upon a heated glass substrate comprising:
a) providing a heated glass substrate having a surface upon which the coating is to be deposited; and
b) premixing monosilane, oxygen, ethylene, triethylphosphate and an inert carrier gas to form a precursor mixture, directing the precursor mixture toward and along the surface to be coated, and reacting the mixture at or near the surface to form a silica coating on the surface of the glass substrate.
